(19) United States
(12) Patent Application Publication
(10) Pub. No.: US 2026/0230316 A1
(43) Pub. Date: Aug. 6, 2026

(54) SYSTEMS AND METHODS FOR CERTIFIED QUANTUM RANDOMNESS EXPANSION USING RANDOM CIRCUIT SAMPLING

(71) Applicant: JPMORGAN CHASE BANK, N.A., New York, NY (US)

(72) Inventors: Enrique CERVERO MARTIN, Singapore (SG); Kaushik CHAKRABORTY, Singapore (SG); Lim Ci WEN, Singapore (SG); Marco PISTOIA, New York, NY (US)

(21) Appl. No.: 19/042,083

(22) Filed: Jan. 31, 2025

(51) Int. Cl. H04L 9/08; H04L 9/32

(52) U.S. Cl. CPC H04L 9/0855; H04L 9/3218

(57) ABSTRACT

A method may include: selecting a random quantum circuit from a family of random quantum circuits; communicating the selected random quantum circuit to a quantum device, wherein the quantum device applies the selected random circuit to its internal state and measures the internal state to obtain a bit string; calculating a probability that the bit string is a result of the selected random quantum circuit; repeating the communicating, the receiving, and the calculating using the selected random quantum circuit or a new random quantum circuit for a number of rounds; collecting a tuple comprising the random quantum circuit communicated to the quantum device, the bit string received from the quantum device, and the probability; computing a validation value for the tuples; validating the validation value; outputting the bit strings to a quantum-proof randomness extractor, wherein the quantum-proof randomness extractor returns a final bit string; and outputting the final bit string.

### BACKGROUND OF THE INVENTION

### 1. Field of the Invention

Embodiments relate to systems and methods for certified quantum randomness expansion using random circuit sampling.

### 2. Description of the Related Art

Quantum Randomness Expansion (QRE) is a cryptographic primitive that allows for the generation of statistically secure randomness from a small random seed in the presence of quantum adversaries.

### SUMMARY OF THE INVENTION

Systems and methods for certified quantum randomness expansion using random circuit sampling are disclosed. In one embodiment, a method may include: (1) selecting, by a computer program, a random quantum circuit from a family of random quantum circuits; (2) communicating, by the computer program, the selected random quantum circuit to a quantum device, wherein the quantum device applies the selected random circuit to its internal state and measures the internal state to obtain a bit string; (3) receiving, by the computer program, the bit string from the quantum device; (4) calculating, by the computer program, a probability that the bit string is a result of the selected random quantum circuit being applied to the internal state of the quantum device based on the bit string and the selected random circuit; (5) repeating, by the computer program, the communicating, the receiving, and the calculating using the selected random quantum circuit or a new random quantum circuit for a number of rounds; (6) collecting, by the computer program, a tuple for each round comprising the random quantum circuit communicated to the quantum device, the bit string received from the quantum device, and the probability; (7) computing, by the computer program, a validation value for the tuples; (8) validating, by the computer program, the validation value by comparing the validation value to a threshold; (9) outputting, by the computer program, the bit strings received from the quantum device to a quantum-proof randomness extractor in response to a successful validation, wherein the quantum-proof randomness extractor returns a final bit string; and (10) outputting, by the computer program, the final bit string.

In one embodiment, the family of random quantum circuits may include quantum circuits of at least unitary 2-design with a sampling probability that has exponentially small variance.

In one embodiment, the family of random quantum circuits may include pseudorandom quantum circuits or fully random quantum circuits.

In one embodiment, the number of rounds may be received from a user.

In one embodiment, the method may also include: deciding, by the computer program, to select the new random quantum circuit; and selecting, by the computer program, the new random quantum circuit from the family of random quantum circuit.

In one embodiment, the deciding may be a random decision based on a decision parameter received from a user.

In one embodiment, the validation value may be based on a linear cross entropy benchmark for the tuples.

In one embodiment, the threshold may be based on an error tolerance parameter that may be received from a user.

In one embodiment, the quantum-proof randomness extractor may be selected from a family of quantum-proof randomness extractors.

In one embodiment, the probability that the bit string is a result of the selected random quantum circuit being applied to the internal state of the quantum device may be calculated only in certain rounds.

According to another embodiment, a non-transitory computer readable storage medium may include instructions stored thereon, which when read and executed by one or more computer processors, cause the one or more computer processors to perform steps comprising: selecting a random quantum circuit from a family of random quantum circuits; communicating the selected random quantum circuit to a quantum device, wherein the quantum device applies the selected random circuit to its internal state and measures the internal state to obtain a bit string; receiving the bit string from the quantum device; calculating a probability that the bit string is a result of the selected random quantum circuit being applied to the internal state of the quantum device based on the bit string and the selected random circuit; repeating the communicating, the receiving, and the calculating using the selected random quantum circuit or a new random quantum circuit for a number of rounds; collecting a tuple for each round comprising the random quantum circuit communicated to the quantum device, the bit string received from the quantum device, and the probability; computing a validation value for the tuples; validating the validation value by comparing the validation value to a threshold; outputting the bit strings received from the quantum device to a quantum-proof randomness extractor in response to a successful validation, wherein the quantum-proof randomness extractor returns a final bit string; and outputting the final bit string.

In one embodiment, the family of random quantum circuits may include quantum circuits of at least unitary 2-design with a sampling probability that has exponentially small variance.

In one embodiment, the family of random quantum circuits may include pseudorandom quantum circuits or fully random quantum circuits.

In one embodiment, the number of rounds may be received from a user.

In one embodiment, the non-transitory computer readable storage medium may also include instructions stored thereon, which when read and executed by the one or more computer processors, cause the one or more computer processors to perform steps comprising: deciding to select the new random quantum circuit; and selecting the new random quantum circuit from the family of random quantum circuit.

In one embodiment, the deciding may be a random decision based on a decision parameter received from a user.

In one embodiment, the validation value may be based on a linear cross entropy benchmark for the tuples.

In one embodiment, the threshold may be based on an error tolerance parameter that may be received from a user.

In one embodiment, the quantum-proof randomness extractor may be selected from a family of quantum-proof randomness extractors.

In one embodiment, the probability that the bit string is a result of the selected random quantum circuit being applied to the internal state of the quantum device may be calculated only in certain rounds.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for certified quantum randomness expansion using random circuit sampling according to an embodiment;

FIGS. 2A and 2B illustrate a method for certified quantum randomness expansion using random circuit sampling according to an embodiment;

FIG. 3 depicts an exemplary computing system for implementing aspects of the present disclosure.

### DETAILED DESCRIPTION OF PREFERRED EMBODIMENTS

Embodiments relate to systems and methods for certified quantum randomness expansion using random circuit sampling. In embodiments, a random seed is used to sample a quantum circuit from a family of quantum circuits. A quantum device then applies the quantum circuit to its internal state, and measures the resulting quantum system to obtain a bit string. The process may then be repeated for a number of rounds.

At the end of the rounds, a user may perform a statistical check on the bit strings to determine whether or not to abort the protocol. If the protocol is not aborted, the bit strings are provided to a quantum-proof randomness extractor, and a final bit string is output.

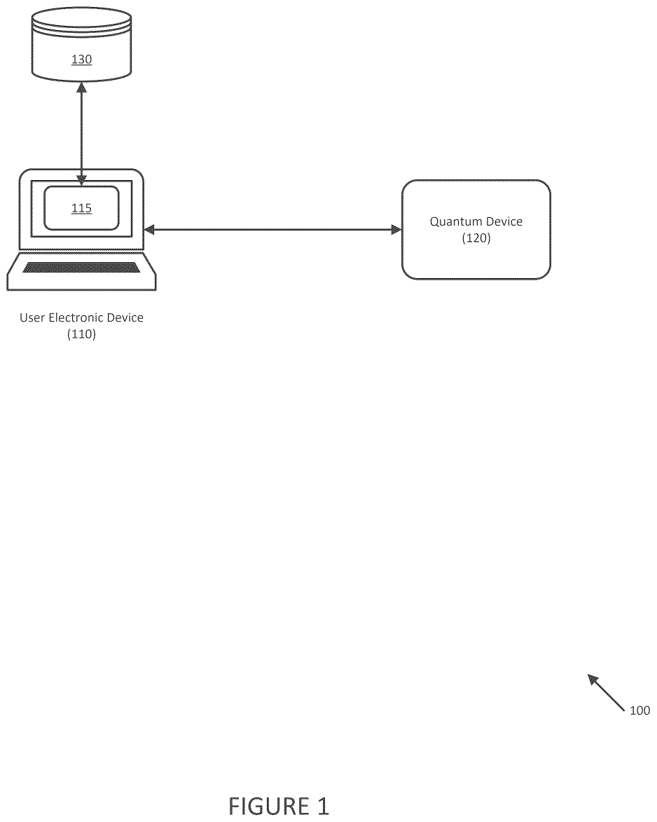

Referring to FIG. 1, a system for certified quantum randomness expansion using random circuit sampling is disclosed according to an embodiment. System 100 may include user electronic device 110, which may be, for example, a computer (e.g., workstation, desktop, laptop, notebook, tablet, etc.), a smart device (e.g., smart phone, smart watch, etc.), and Internet of Things (IoT) appliance, etc. User electronic device 110 may execute user computer program 115.

System 100 may further include database 130 that may store a plurality of quantum circuits. The quantum circuits may be at least unitary 2-design and be such that their sampling probability has exponentially small variance. They can otherwise be pseudorandom, or fully random.

User computer program 115 may communicate with quantum device 120, such as a quantum computer. Quantum device 120 may be a Noisy Intermediate Scale Quantum (NISQ) device. Quantum device 120 may include a plurality of qubits and may have inherent noise.

Quantum device 120 may receive a random quantum circuit selected by user computer program 115, and may apply it to its internal state, such as its qubits. Quantum device 120 may apply the gates of the random quantum circuit to the qubits. The manner of application may depend on the specific type of quantum device 120.

Quantum device 120 may measure the result of the application, and may return a n-bit string to user computer program 115. For example, quantum device 120 may receive a classical description of the quantum circuit, may apply this circuit, may measure the internal state in the computational basis, and may return the outcome to user computer program 115.

User computer program 115 may then calculate a probability that the n-bit string was a result of the random quantum circuit being applied to the state of the quantum device.

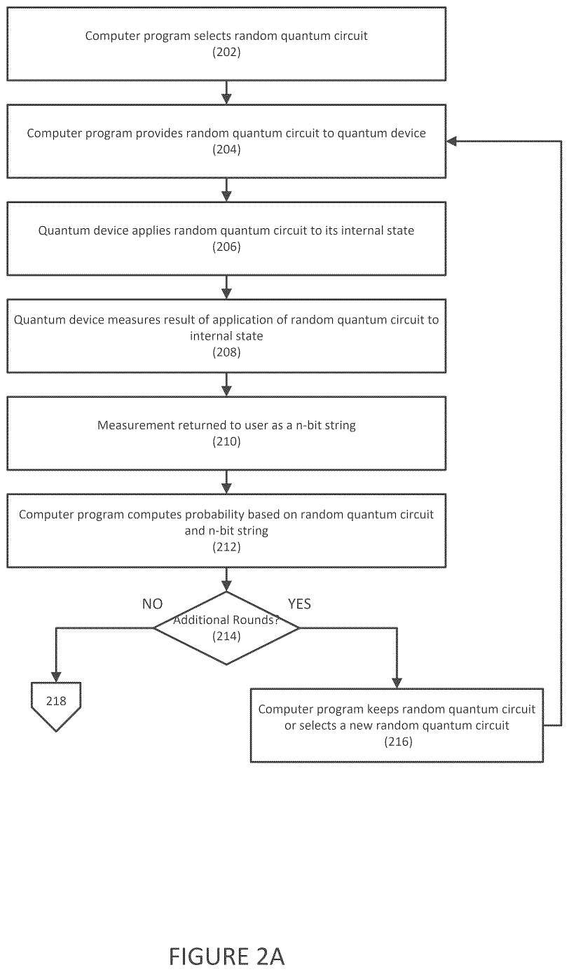

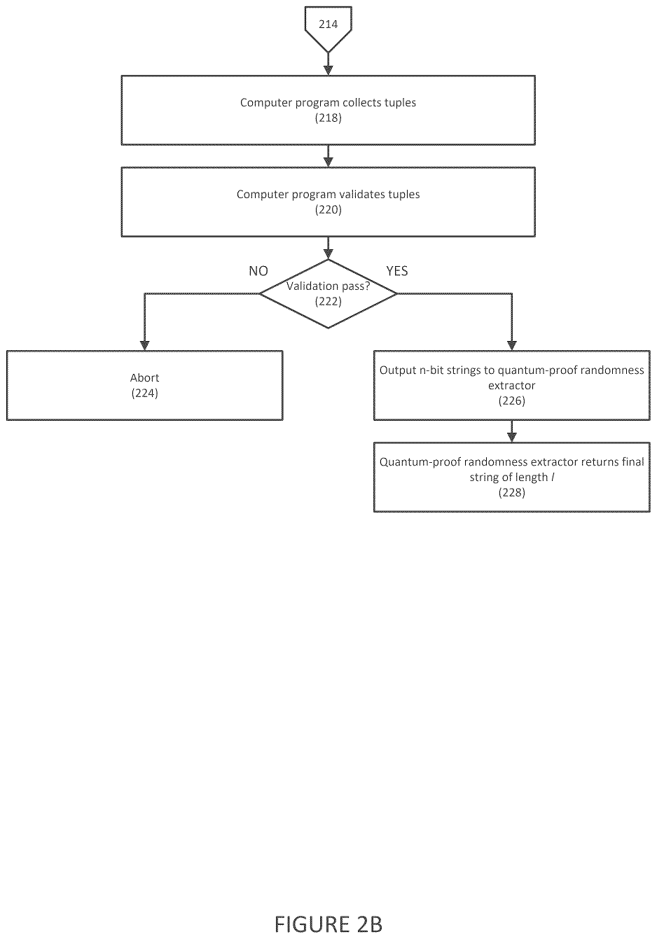

Referring to FIGS. 2A and 2B, a method for certified quantum randomness expansion using random circuit sampling is disclosed according to an embodiment is disclosed according to an embodiment.

In step 202, a user computer program executed by a user electronic device may randomly select a quantum circuit from a library or database of quantum circuits. The quantum circuits may be at least unitary 2-design and be such that their sampling probability has exponentially small variance. They can otherwise be pseudorandom, or fully random.

In one embodiment, a family of quantum circuits to be selected from may be an input received from the user. The family of quantum circuits may be a pseudorandom family, a random family, a unitary design, an anti-concentrating family, etc. In one embodiment, the family of quantum circuits may be selected by the user.

In one embodiment, the selection of a quantum circuit from the identified family of quantum circuits may be uniformly random.

In one embodiment, the user computer program may receive a number of rounds of quantum device interactions. In one embodiment, the number of rounds may be a parameter provided by the user. In general, the randomness increases with additional rounds.

The user computer program may also receive a number of qubits, n, to be used as a parameter, such that all random quantum circuits submitted are n-qubit quantum circuits.

The user may also provide a privacy amplification parameter and a privacy estimation parameter. These parameters influence the security guarantees and generated randomness of the protocol. In general, more stringent security parameters implies a smaller output which is more secure, whereas laxer security parameters allow for a larger output at the cost of security.

In step 204, the user computer program may provide the random quantum circuit to a quantum device. In one embodiment, the quantum device may be a near-term quantum device.

In step 206, the quantum device may apply the random quantum circuit to its internal state.

In step 208, the quantum device may measure a result of the application of random quantum circuit to its internal state.

In step 210, the quantum device may return the measurement returned as a n-bit string, X.

In step 212, the user computer program may compute a probability that the n-bit string was a result of the random quantum circuit. The computed probability is the probability that the quantum device measured the string X received by the user when applying the circuit sent by the user. This calculation may be performed analytically using classical computing.

The probability may be a multiplication of very large matrices. For example, the matrix multiplication may be stored as a tensor network and the network may provide the resulting probability.

In one embodiment, the probability may not be calculated during every round. For example, in every round, a biased coin (with a probability Y) may be flipped, and if the outcome is 1 (with a probability Y), the bit string related probability is computed. The value of Y may be received as a parameter from the user.

In step 214, if there are additional rounds, in step 216, the user computer program may either keep the current random quantum circuit selection or may randomly select a new quantum circuit. The process may then return to step 204.

In one embodiment, selecting a quantum circuit consumes the initial random seed. Embodiments may seek to minimize the amount of randomness consumed while maximizing the net randomness produced.

In one embodiment, the decision to select a new quantum circuit may be a random decision, with a high probability (1-nu) the same quantum circuit as last round is used and a low probability (nu) a new quantum circuit is selected. The value for the decision parameter nu may be provided by the user.

If there are no additional rounds, in step 218, the user computer program may collect tuples (U, X, p_{U(X)}), each tuple including the quantum circuit (U), bit string (X) from the quantum circuit, and the probability (p_{U(X)}) that the bitstring was measured from the quantum circuit U.

In step 220, the user computer program may validate the tuples. For example, the user computer program may compute a validation value, which is a variation on the LXEB (linear cross entropy benchmark) score, as follows:

$$\frac{1}{\vert {T}_{t e s t} \vert} {\sum }_{i ∈ {T}_{t e s t}} {p}_{{U}_{i}} ( {X}_{i} )$$

Where Tₜₑₛₜ is the set of rounds for which probabilities were calculated.

In step 222, the validation value may be compared to a threshold, which may be calculated as follows:

$$\frac{2 - ϵ}{{2}^{n} + 1}$$

where ϵ is the error tolerance parameter for the parameter estimation that may be set by the user. If ϵ ha a high value, the protocol succeeds more often but produces less randomness; if ϵ is low, the protocol fails more often but produces more randomness.

In step 222, if the validation fails (i.e., the validation value is less than the threshold), in step 224, the process may abort.

If, in step 222, the validation passes (i.e., the validation value is greater than or equal to the threshold), in step 226, the user computer program may output the n-bit strings to a quantum-proof randomness extractor. Examples of quantum-proof randomness extractors are described in Berta et al., “Quantum-proof randomness extractors via operator space theory,” IEEE Transactions on Information Theory 63 (4), 2480-2503 (2017), the disclosure of which is hereby incorporated, by reference, in its entirety.

In one embodiment, the user computer program may select a quantum-proof randomness extractor (H_{PA}) from a family of quantum-proof randomness extractors. The quantum-proof randomness extractor may be a parameter chosen by the user. In one embodiment, the quantum-proof randomness extractor may be selected from the family of randomness extractor at random.

In step 228, the selected quantum-proof randomness extractor may be applied to the M bit-strings of raw data returned by the quantum device, and may return a final string of length l to the user computer program. The final string is guaranteed to be statistically close to a uniformly random i-bit strings of bits.

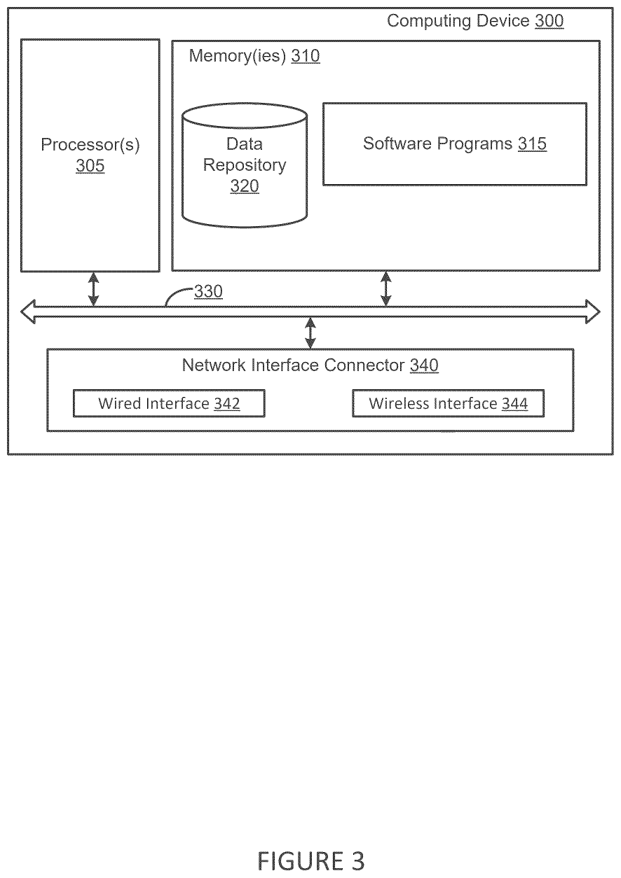

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
selecting, by a computer program, a random quantum circuit from a family of random quantum circuits;
communicating, by the computer program, the selected random quantum circuit to a quantum device, wherein the quantum device applies the selected random circuit to its internal state and measures the internal state to obtain a bit string;
receiving, by the computer program, the bit string from the quantum device;
calculating, by the computer program, a probability that the bit string is a result of the selected random quantum circuit being applied to the internal state of the quantum device based on the bit string and the selected random circuit;
repeating, by the computer program, the communicating, the receiving, and the calculating using the selected random quantum circuit or a new random quantum circuit for a number of rounds;
collecting, by the computer program, a tuple for each round comprising the random quantum circuit communicated to the quantum device, the bit string received from the quantum device, and the probability;
computing, by the computer program, a validation value for the tuples;
validating, by the computer program, the validation value by comparing the validation value to a threshold;
outputting, by the computer program, the bit strings received from the quantum device to a quantum-proof randomness extractor in response to a successful validation, wherein the quantum-proof randomness extractor returns a final bit string; and
outputting, by the computer program, the final bit string.

2. The method of claim 1, wherein the family of random quantum circuits comprise quantum circuits of at least unitary 2-design with a sampling probability that has exponentially small variance.

3. The method of claim 1, wherein the family of random quantum circuits comprise pseudorandom quantum circuits or fully random quantum circuits.

4. The method of claim 1, wherein the number of rounds is received from a user.

5. The method of claim 1, further comprising:
deciding, by the computer program, to select the new random quantum circuit; and
selecting, by the computer program, the new random quantum circuit from the family of random quantum circuit.

6. The method of claim 5, wherein the deciding is a random decision based on a decision parameter received from a user.

7. The method of claim 1, wherein the validation value is based on a linear cross entropy benchmark for the tuples.

8. The method of claim 1, wherein the threshold is based on an error tolerance parameter that is received from a user.

9. The method of claim 1, wherein the quantum-proof randomness extractor is selected from a family of quantum-proof randomness extractors.

10. The method of claim 1, wherein the probability that the bit string is a result of the selected random quantum circuit being applied to the internal state of the quantum device is calculated only in certain rounds.

11. A non-transitory computer readable storage medium, including instructions stored thereon, which when read and executed by one or more computer processors, cause the one or more computer processors to perform steps comprising:
selecting a random quantum circuit from a family of random quantum circuits;
communicating the selected random quantum circuit to a quantum device, wherein the quantum device applies the selected random circuit to its internal state and measures the internal state to obtain a bit string;
receiving the bit string from the quantum device;
calculating a probability that the bit string is a result of the selected random quantum circuit being applied to the internal state of the quantum device based on the bit string and the selected random circuit;
repeating the communicating, the receiving, and the calculating using the selected random quantum circuit or a new random quantum circuit for a number of rounds;
collecting a tuple for each round comprising the random quantum circuit communicated to the quantum device, the bit string received from the quantum device, and the probability;
computing a validation value for the tuples;
validating the validation value by comparing the validation value to a threshold;
outputting the bit strings received from the quantum device to a quantum-proof randomness extractor in response to a successful validation, wherein the quantum-proof randomness extractor returns a final bit string; and
outputting the final bit string.

12. The non-transitory computer readable storage medium of claim 11, wherein the family of random quantum circuits comprise quantum circuits of at least unitary 2-design with a sampling probability that has exponentially small variance.

13. The non-transitory computer readable storage medium of claim 11, wherein the family of random quantum circuits comprise pseudorandom quantum circuits or fully random quantum circuits.

14. The non-transitory computer readable storage medium of claim 11, wherein the number of rounds is received from a user.

15. The non-transitory computer readable storage medium of claim 11, further including instructions stored thereon, which when read and executed by the one or more computer processors, cause the one or more computer processors to perform steps comprising:
deciding to select the new random quantum circuit; and
selecting the new random quantum circuit from the family of random quantum circuit.

16. The non-transitory computer readable storage medium of claim 15, wherein the deciding is a random decision based on a decision parameter received from a user.

17. The non-transitory computer readable storage medium of claim 11, wherein the validation value is based on a linear cross entropy benchmark for the tuples.

18. The non-transitory computer readable storage medium of claim 11, wherein the threshold is based on an error tolerance parameter that is received from a user.

19. The non-transitory computer readable storage medium of claim 11, wherein the quantum-proof randomness extractor is selected from a family of quantum-proof randomness extractors.

20. The non-transitory computer readable storage medium of claim 11, wherein the probability that the bit string is a result of the selected random quantum circuit being applied to the internal state of the quantum device is calculated only in certain rounds.
